(19) United States
(12) Patent Application Publication
(10) Pub. No.: US 2010/0037018 A1
(43) Pub. Date: Feb. 11, 2010

(54) DRIVE TRAY BASED CACHING FOR HIGH PERFORMANCE DATA STORAGE SYSTEMS

(76) Inventor: Ciril Ignatious T, Thrissur (IN)

Correspondence Address: Global IP Services, PLLC, 10 Crestwood Lane, Nashua, NH, 03062, US

(21) Appl. No.: 12/188,216

(22) Filed: Aug. 8, 2008

(51) Int. Cl. G06F 12/00

(52) U.S. Cl. 711/113; 711/E12.001

(57) ABSTRACT

Methods and systems of drive tray based caching for high performance data storage systems are disclosed. In one embodiment, the data storage system includes a controller module with at least one storage controller for managing flow of data associated with an application software, and a plurality of drive trays. Each drive tray includes a plurality of drives for storing a respective portion of the data and at least one drive controller for managing flow of the respective portion of the data between the at least one storage controller and the plurality of drives. Also, each drive tray includes a drive cache memory coupled to each one of the at least one drive controller for caching the respective portion of the data.

### FIELD OF TECHNOLOGY

Embodiments of the present invention relate to the field of electronics. More particularly, embodiments of the present invention relate to data management for storage systems.

### BACKGROUND

Storage systems store information for subsequent use or retrieval. Among the storage systems, a storage area network (SAN), a network attached system (NAS), or a direct-attached storage (DAS) may be used to store data associated with one or more servers, which provide one or more application software to a data storage device either through a network or directly. In the storage systems, the data are written and/or read from the data storage device, which is generally made of multiple drives in a set of drive trays. For example, a single enclosure or cabinet of the data storage device may include fourteen drive trays stacked on top of each other, with each drive tray having fourteen to sixteen drives.

When the data are written to and/or read from the data storage device of the storage systems, a storage controller of the data storage device may be used to manage flow of data in and out of the data storage device. However, when the storage controller of the data storage device is accessed for large chunks of read and/or write requests, which call for heavy input/output (I/O) operations, some of the data may have to wait in queue to be written to and/or read from the data storage device while other data are being written to and/or read from the data storage device. This, in turn, reduces (e.g., slows down) performance of the storage systems. Cache of the storage controller may be increased to reduce the bottleneck effect. However, increase in the cache by more than a certain amount may generate more cache misses, where the cache is consulted and found not to contain a datum with a desired tag. Thus, the increase of the cache may not be a viable solution during such heavy I/O operations of the storage systems.

### SUMMARY

Methods and systems of drive tray based caching for high performance data storage systems are disclosed. In one aspect, a data storage system includes a controller module with at least one storage controller for managing flow of data associated with an application software, and a plurality of drive trays. Each drive tray includes a plurality of drives for storing a respective portion of the data, and at least one drive controller for managing flow of the respective portion of the data between the at least one storage controller and the plurality of drives. Also, each drive tray includes a drive cache memory coupled to each one of the at least one drive controller for caching the respective portion of the data.

In another aspect, a method for managing flow of data in a drive tray of a data storage system includes receiving a command signal from a storage controller which manages the flow of the data between an application software and the data storage system. The method also includes accessing at least one drive cache memory associated with the drive tray to perform an input/output (I/O) operation for a respective portion of the data based on the command signal.

The methods disclosed herein may be implemented by any means for achieving various aspects, and may be executed in a form of a machine readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Embodiments of the present invention are illustrated by way of examples and not limited to the figures of the accompanying drawings, in which like references indicate similar elements and in which:

FIG. 1 is a block diagram of an exemplary data storage system having a drive cache memory for each drive controller, according to one embodiment.

FIG. 2 is a block diagram of an exemplary storage area network (SAN), according to one embodiment.

FIG. 3 is a block diagram of an exemplary network attached storage (NAS), according to one embodiment.

FIG. 4 is a block diagram of an exemplary direct-attached storage (DAS), according to one embodiment.

FIG. 5 is a process flow chart for an exemplary method for managing flow of data in a drive tray of a data storage system, according to one embodiment.

FIG. 6 is a process flow chart for an exemplary method for reading data from a drive tray of a data storage system, according to one embodiment.

FIG. 7 is a process flow chart for an exemplary method for writing data to a drive tray of a data storage system, according to one embodiment.

Other features of the present embodiments will be apparent from the accompanying drawings and from the detailed description that follows.

### DETAILED DESCRIPTION

Methods and systems of drive tray based caching for high performance data storage systems are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

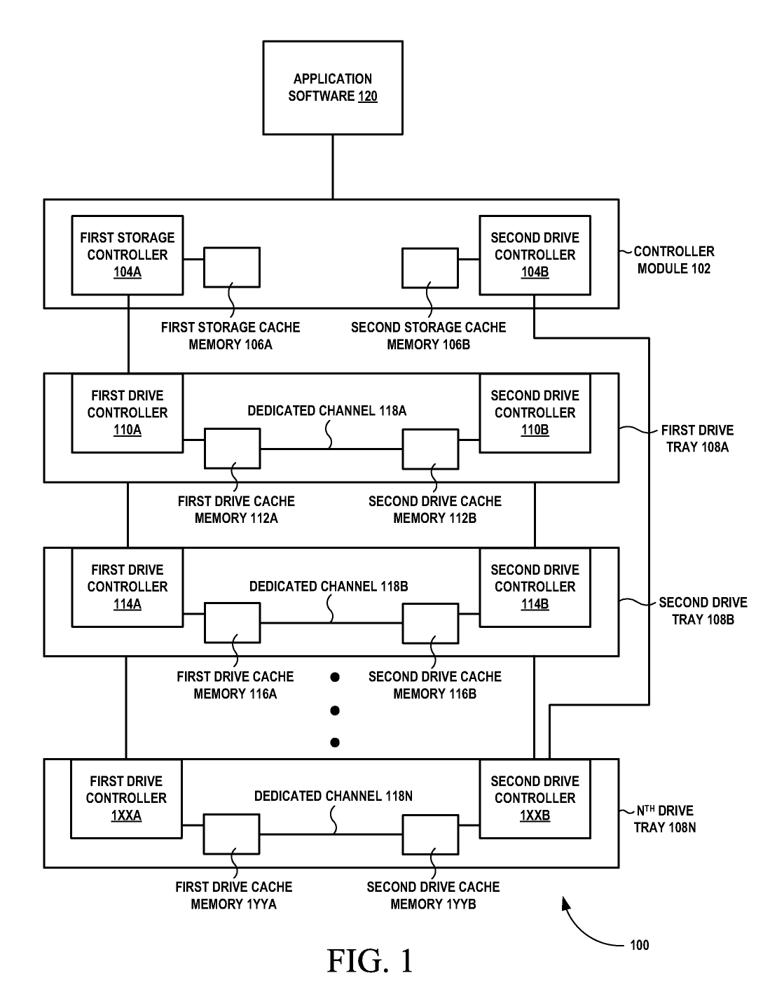

FIG. 1 is a block diagram of an exemplary data storage system 100 having a drive cache memory for each drive controller, according to one embodiment. Particularly, the data storage system 100 includes a controller module 102 having a first storage controller 104A and a second storage controller 104B. In one embodiment, the controller module 102 manages flow of data associated with an application software 120. Further as shown in FIG. 1, the controller module 102 includes a first storage cache memory 106A and a second storage cache memory 106B coupled to the first storage controller 104A and the second storage controller 104B respectively.

In one example embodiment, the first storage cache memory 106A and the second cache memory 106B are used for caching the data associated with the application software 120. Also, as shown in FIG. 1, the data storage system 100 includes drive trays 108A through 108N. Each of the drive trays 108A through 108N includes multiple drives (not shown) for storing a respective portion of the data. In one exemplary implementation, 16 drive trays may be stacked in the data storage system 100 with each drive tray having 14 to 16 drives.

As shown in FIG. 1 the first drive tray 108A includes a first drive controller 110A and a second drive controller 110B. Similarly, the second drive tray 108B includes a first drive controller 114A and a second drive controller 114B, and the Nth drive tray 108N includes a first drive controller 1XXA and a second drive controller 1XXB. In one embodiment, the drive controllers in the drive trays 108A through 108N manage flow of the respective portion of the data between the storage controllers 104A and 104B and the drives. Further as shown in FIG. 1, the first drive tray 108A includes a first drive cache memory 112A and a second drive cache memory 112B coupled to the first drive controller 110A and the second drive controller 110B, respectively. Similarly, the second drive tray 108B includes a first drive cache memory 116A and a second drive cache memory 116B coupled to the first drive controller 114A and the second drive controller 114B, respectively, and the Nth drive tray 108N includes a first drive cache memory 1YYA and a second drive cache memory 1YYB coupled to the first drive controller 1XXA and the second drive controller 1XXB, respectively. In one embodiment, the drive cache memories in the drive trays 108A through 108N are used for caching the respective portion of the data.

It is appreciated that the first drive controller 110A and the second drive controller 110B of the first drive tray 108A are coupled using a dedicated channel 118A. Similarly, the first drive controller 114A and the second drive controller 114B of the second drive tray 108B are coupled using a dedicated channel 118B and the first drive controller 1XXA and the second drive controller 1XXB of the Nth drive tray 108N are coupled using a dedicated channel 118N.

In one exemplary implementation, each of the dedicated channels 118A through 118N is operable for cache mirroring of the first drive controller and the second drive controller of its respective drive tray. In another exemplary implementation, each of the dedicated channels 118A through 118N is operable for cache synchronization of the first drive controller and the second drive controller of its respective drive tray. The below description is with respect to the first drive tray 108A, which is similar for all the other drive trays in the data storage system 100.

It is appreciated that the first drive controller 110A and second drive controller 110B in the first drive tray 108A are deemed as intelligent drive controllers with cache mirroring and cache synchronization at a drive tray level. In one example embodiment, cache mirroring refers to a process of mirroring data in the first drive cache memory 112A and second drive cache memory 112B within the first drive tray 108A. The cache mirroring enables accessing (e.g., retrieving) of the respective portion of the data from one of the drive controllers 110A and 110B due to redundancy in the respective portion of the data (e.g., when other one of the drive controllers 110A and 110B fails). In another example embodiment, cache synchronization refers to a process in which writing the respective portion of the data is performed synchronously to the drive cache memories 112A and 112B. It is appreciated that both cache mirroring and cache synchronization increase overall performance of the data storage system 100 in processing read and write commands in a large enterprise configuration.

Further, it can be seen from FIG. 1 that, the data storage system 100 includes a redundant loop in a drive channel side of the controller module 102. For example, the controller module 102 has two channels, one in application software side and another in drive tray side, each channel passing through either one of the two drive controllers in the drive trays 108A through 108N.

In operation, an input/output (I/O) request associated with the application software 120 is pumped into the controller module 102 for processing the I/O request. Based on the I/O request, data is either read from the drive trays 108A through 108N or written into the drive trays 108A and 108N. In one embodiment, the first drive controller 110A and the second drive controller 110B of the first drive tray 108A are operable for fetching read data from the respective drive cache memories 112A and 112B based on a read request from the storage controllers 104A and 104B, where the read request may be originated from the application software 120, and for forwarding the read data to the storage controllers 104A and 104B. In another embodiment, the first drive controller 110A and the second drive controller 110B of the first drive tray 108A are operable for temporarily storing write data forwarded by the storage controllers 104A and 104B, where the write data may be originated from the application software 120, in the respective drive cache memories 112A and 112B and for writing the write data in the drives.

When the application software 120 issues heavy read commands (e.g., ranging from a few kilobytes to a few megabytes) to the controller module 102, the storage controllers 104A and 104B of the controller module 102 pass these read commands to the first drive controller 110A and the second drive controller 110B to fetch a respective portion of data from appropriate physical sectors of the drives in the first drive tray 108A. It is appreciated that due to presence of the drive cache memories 112A and 112B in the first drive tray 108A, more read commands are accepted from the storage controllers 104A and 104B of the controller module 102. Further, the respective portion of the data is fetched in advance into the drive cache memories 112A and 112B from the drives of the first drive tray 108A and forwarded to the storage controllers 104A and 104B of the controller module 102. Thus, read performance of the entire data storage system 100 is enhanced.

Also, when the application software 120 pumps heavy write commands (e.g., ranging from a few kilobytes to a few megabytes) to the controller module 102, the storage controllers 104A and 104B of the controller module 102 forward these write commands to the first drive controller 110A and the second drive controller 110B for writing a respective portion of data to the drives in the first drive tray 108A. It is appreciated that due to the presence of the drive cache memories 112A an 112B in the first drive tray 108A, the respective portion of the data is accepted from the storage controllers 104A and 104B of the controller module 102 and stored in the drive cache memories 112A and 112B. Further, the respective portion of data is flushed to the respective drives of the first drive tray 108A for writing. Thus, write performance of the entire data storage system 100 is enhanced.

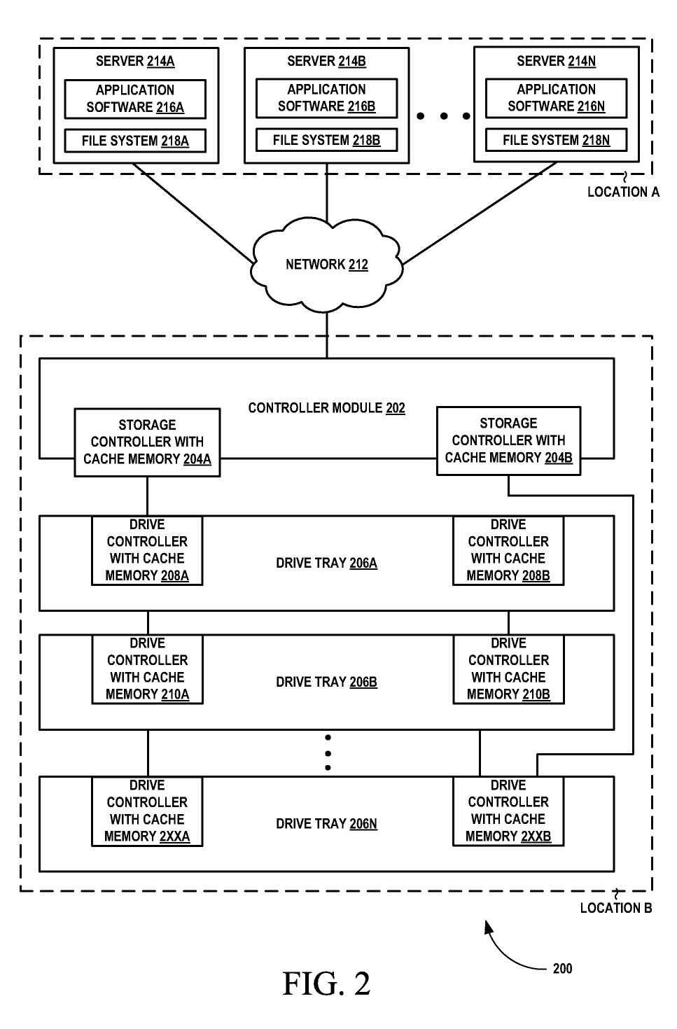

FIG. 2 is a block diagram of an exemplary storage area network (SAN) 200, according to one embodiment. It is appreciated that the SAN 200 is an exemplary embodiment of the data storage system 100 of FIG. 1. As shown in FIG. 2, the SAN 200 includes a controller module 202 and drive trays 206A through 206N, located at a location B.

Further as shown in FIG. 2, the controller module 202 includes storage controllers with cache memories 204A and 204B for managing flow of data associated with application software 216A through 216N. Also, the drive tray 206A includes drive controllers with cache memories 208A and 208B, the drive tray 206B includes drive controllers with cache memories 210A and 210B and the drive tray 206N includes drive controllers with cache memories 2XXA and 2XXB. It is appreciated that each of the drive trays 206A through 206N includes drive controllers with drive cache memories for managing respective portions of the data. The application software 216A through 216N and respective file systems 218A through 218N reside in servers 214A through 214N, respectively, at location A. Further, the servers 214A through 214N at the location A are remotely located from the controller module 202 and the drive trays 206A through 206N (both located at the location B). As shown in FIG. 2, the servers 214A through 214N are coupled to the controller module 202 using a network 212 (e.g., FC, GbE, etc.).

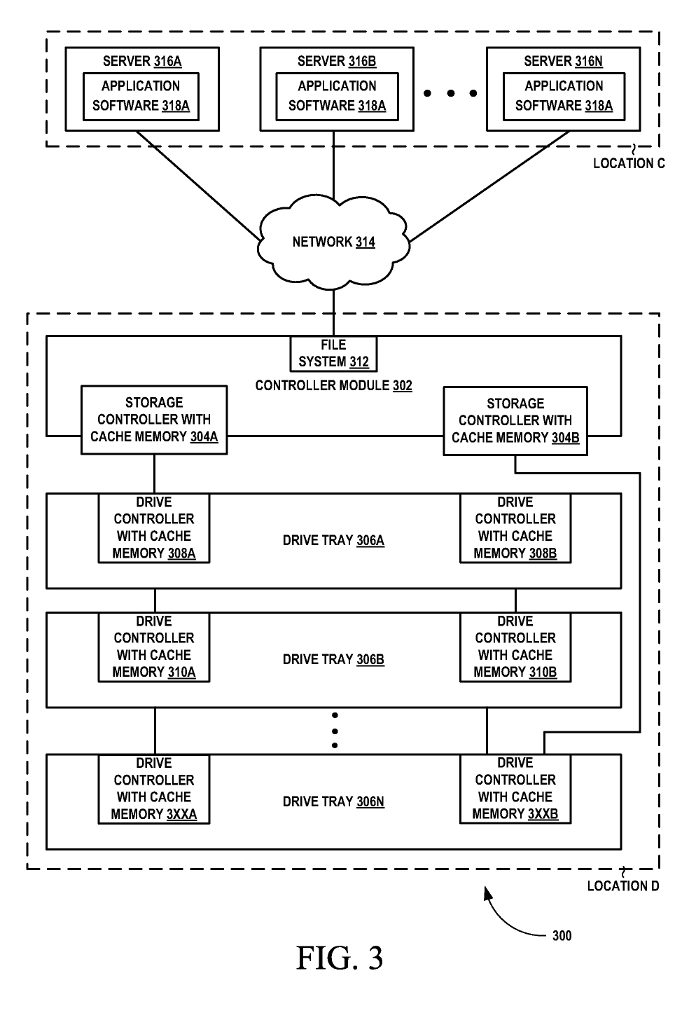

FIG. 3 is a block diagram of an exemplary network attached storage (NAS) 300, according to one embodiment. It is appreciated that the NAS 300 is an exemplary embodiment of the data storage system 100 of FIG. 1. As shown in FIG. 3, a controller module 302 and drive trays 306A through 306N are located at a location D. The controller module 302 includes storage controllers with cache memories 304A and 304B for managing flow of data associated with application software 318A through 318N.

Furthermore, the drive tray 306A includes drive controllers with drive cache memories 308A and 308B, the drive tray 306B includes drive controllers with cache memories 310A and 310B, and the drive tray 306N includes drive controllers with cache memories 3XXA and 3XXB. It is appreciated that each of the drive trays 306A through N include drive controllers with cache memories for managing a respective portion of the data. The application software 318A through N reside in servers 316A through N, located at a location C. In one exemplary implementation, the servers 316A through N are remotely located from the controller module 302 and the drive trays 306A through N of the NAS 300. Further, in FIG. 3, a respective file system 312 which is proximately located to the controller module 302 is coupled to the application software 318A through N using a network 314 (e.g., transfer control protocol/internet protocol (TCP/IP) network).

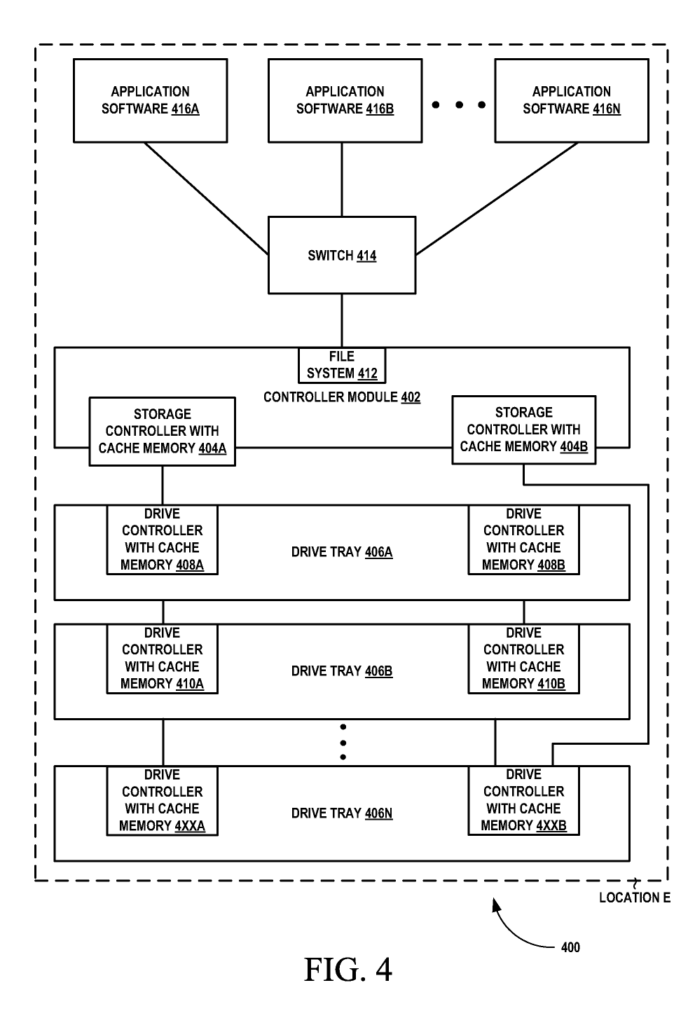

FIG. 4 is a block diagram of an exemplary direct-attached storage (DAS) 400, according to one embodiment. It is appreciated that the DAS 400 is an exemplary embodiment of the data storage system 100 of FIG. 1. As shown in FIG. 4, the DAS 400 includes a controller module 402, drive trays 406A through N and application software 416A through N, all located at a location E. The controller module 402 includes storage controllers with cache memories 404A and 404B for managing flow of data associated with the application software 416A through N. Further, the drive tray 406A includes drive controller with cache memories 408A and 408B, the drive tray 406B includes drive controllers with cache memories 410A and 410B and the drive tray 406N includes drive controllers with cache memories 4XXA and 4XXB. It is appreciated that each of the drive trays 406A through N include drive controllers with drive cache memories for managing a respective portion of the data. In one exemplary implementation, a respective file system 412 and the application software 416A through N are directly coupled to the controller module 402 via a switch 414.

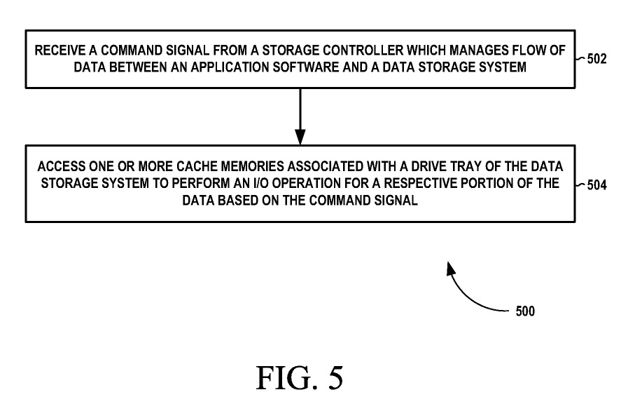

FIG. 5 is a process flow chart for an exemplary method 500 for managing flow of data in a drive tray of a data storage system, according to one embodiment. In one embodiment, the data storage system may be a storage area network (SAN), a network attached storage (NAS), or a direct-attached storage (DAS). In step 502, a command signal is received from a storage controller which manages flow of data between an application software and the data storage system. In step 504, one or more drive cache memories associated with the drive tray of the data storage system are accessed to perform an input/output (I/O) operation for a respective portion of the data, based on the command signal. In one example embodiment, the command signal includes a write command and a read command.

Moreover, in one example embodiment, a computer readable medium (e.g., firmware for I/O processor and/or controller module associated with the data storage system of FIG. 1, FIG. 2, FIG. 3 and FIG. 4) for managing flow of data in the drive tray of the data storage system has instructions that, when executed by a computer, cause the computer to perform the method of FIG. 5.

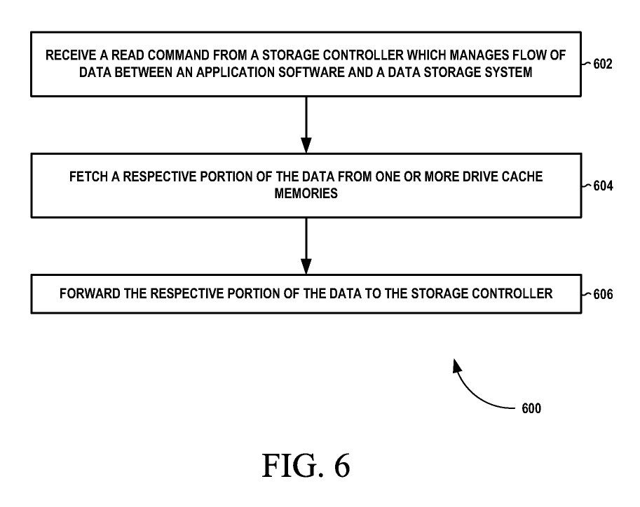

FIG. 6 is a process flow chart for an exemplary method 600 for reading data from a drive tray of a data storage system, according to one embodiment. In step 602, a read command is received from a storage controller which manages flow of data between an application software and the data storage system. In one embodiment, one or more drive cache memories associated with the drive tray are accessed to perform an I/O operation for a respective portion of the data, based on the read command. In step 604, the respective portion of the data is fetched from the one or more drive cache memories associated with the drive tray. In step 606, the respective portion of the data is forwarded to the storage controller.

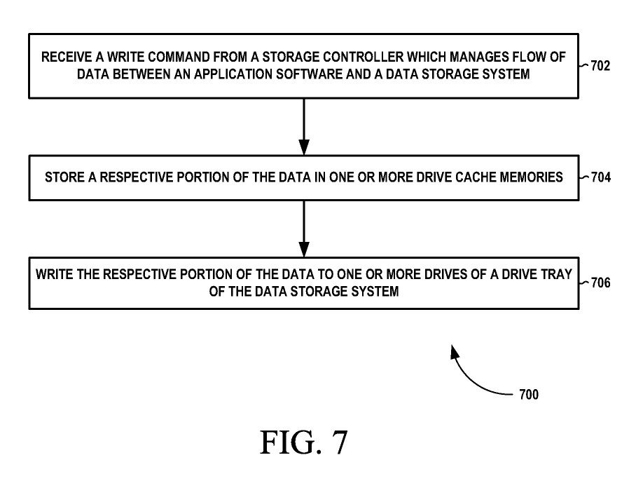

FIG. 7 is a process flow chart for an exemplary method 700 for writing data to a drive tray of a data storage system, according to one embodiment. In step 702, a write command is received from a storage controller which manages flow of data between an application software and the data storage system. In one embodiment, one or more cache drive memories associated with the drive tray are accessed to perform an I/O operation for a respective portion of the data, based on the write command. In step 704, the respective portion of the data is stored in one or more drive cache memories. In step 706, the respective portion of the data is written to one or more drives of the drive tray of the data storage system. In one example embodiment, each drive tray includes two drive cache memories. It is appreciated that writing the respective portion of the data is performed synchronously to the two drive cache memories.

The above-described method and/or system enhances read and write performance for an entire data storage system. Further, in the above-described technique, bottlenecks of hard drive performances compared to interface performance are avoided. In addition, the above-described technique enables redundancy of cache data in the drive controllers through cache mirroring and cache synchronization. Furthermore, the above-described data storage system can be used in high performance computing systems that require high performance storage subsystems.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry ASIC).

What is claimed is:

1. A data storage system, comprising:
a controller module with at least one storage controller for managing flow of data associated with an application software; and
a plurality of drive trays, with each drive tray including:
a plurality of drives for storing a respective portion of the data;
at least one drive controller for managing flow of the respective portion of the data between the at least one storage controller and the plurality of drives; and
a drive cache memory coupled to each one of the at least one drive controller for caching the respective portion of the data.

2. The system of claim 1, wherein the controller module further comprises a storage cache memory coupled to each one of the at least one storage controller for caching the data associated with the application software.

3. The system of claim 1, wherein the at least one drive controller comprises a first drive controller and a second drive controller.

4. The system of claim 3, wherein the first drive controller and the second drive controller are coupled using a dedicated channel.

5. The system of claim 4, wherein the dedicated channel is operable for cache mirroring of the first drive controller and the second drive controller.

6. The system of claim 4, wherein the dedicated channel is operable for cache synchronization of the first drive controller and the second drive controller.

7. The system of claim 1, wherein the at least one drive controller is operable for fetching read data from the drive cache memory based on a read request from the at least one storage controller and for forwarding the read data to the at least one storage controller.

8. The system of claim 1, wherein the at least one drive controller is operable for temporarily storing write data forwarded by the at least one storage controller in the drive cache memory and for writing the write data to the plurality of drives.

9. The system of claim 1, wherein the application software and a respective file system reside in a server remotely located from the controller module and the server is coupled to the controller module using a network.

10. The system of claim 1, wherein the application software resides in a server remotely located from the controller module and the plurality of drive trays, and a respective file system proximately, located to the controller module, is coupled to the server using a network.

11. The system of claim 1, wherein the application software and a respective file system are directly coupled to the controller module.

12. A method for managing flow of data in a drive tray of a data storage system, comprising
receiving a command signal from a storage controller which manages the flow of the data between an application software and the data storage system; and
accessing at least one drive cache memory associated with the drive tray to perform an input/output (I/O) operation for a respective portion of the data based on the command signal.

13. The method of claim 12, wherein the data storage system comprises a storage area network (SAN), a network attached storage (NAS), and a direct-attached storage (DAS).

14. The method of claim 12, wherein the command signal comprises a write command and a read command.

15. The method of claim 14, wherein the accessing the at least one drive cache memory comprises:
fetching the respective portion of the data from the at least one drive cache memory; and
forwarding the respective portion of the data to the storage controller, when the command signal is the read command.

16. The method of claim 14, wherein the accessing the at least one drive cache memory comprises:
storing the respective portion of the data in the at least one drive cache memory; and
writing the respective portion of the data to at least one drive of the drive tray, when the command signal is the write command.

17. The method of claim 16, wherein the at least one drive cache memory comprises two drive cache memories.

18. The method of claim 17, wherein the writing the respective portion of the data is performed synchronously to the two drive cache memories.

19. A computer readable medium for managing flow of data in a drive tray of a data storage system having instructions that, when executed by a computer, cause the computer to perform a method comprising:
receiving a command signal from a storage controller which manages the flow of the data between an application software and the data storage system; and
accessing at least one drive cache memory associated with the drive tray to perform an input/output (I/O) operation for a respective portion of the data based on the command signal.

20. The computer readable medium of claim 19, wherein the data storage system comprises multiple ones of the drive tray with each one of the drive tray enclosing a plurality of drives.
